(19) United States
(12) Patent Application Publication
(10) Pub. No.: US 2015/0220897 A1
(43) Pub. Date: Aug. 6, 2015

(54) INTELLIGENT DEVICE CHARGING STATION

(71) Applicant: Chargesafe LLC, Tampa, FL (US)

(72) Inventors: Vaughn WEATHERDON, Doha (QA); Bryce Galen, New York, NY (US); Fahad Ghaffar, New York, NY (US)

(73) Assignee: CHARGESAFE LLC, Tampa, FL (US)

(21) Appl. No.: 14/169,899

(22) Filed: Jan. 31, 2014

(51) Int. Cl. G06Q 20/18

(52) U.S. Cl. CPC G06Q 20/18

(57) ABSTRACT

Systems and methods for securely and intelligently charging mobile devices are provided. In one embodiment, the charging system obtains data associated with a payment method, makes a determination as to whether there are any available charging bays, attempts to charge the account associated with the payment data, and, responsive to a determination that the payment was successful, opens the door of the available charging bay and presents a user interface comprising information regarding connection of the mobile device.

### BACKGROUND OF THE INVENTION

Embodiments of the present invention relate generally to systems and methods for charging mobile devices. More specifically, embodiments of the present invention relate to providing intelligent and secure battery charging services.

Mobile computing devices have taken on greatly increased roles over the past several years. After an initial focus on telephony, they have increased in capability to include photography, navigation, entertainment, and other functions. As such, the perceived hardship from a device becoming unusable due to a lack of battery charge has increased.

Oftentimes, an overnight charge of a mobile device will provide sufficient battery charge for a normal day of usage. However, if an overnight charge is forgotten, or if the device is used excessively early in the day, the device may be left with insufficient charge for the remainder of the day.

Potential opportunities for recharging a device exist at locations where a user will spend a significant amount of time, such as a restaurant, café, or airline terminal. Most users, however, do not frequently carry charging hardware, and open power outlets can be difficult to find.

Operators of these public locations have very limited incentive, and some significant disincentives, to provide charging hardware for patrons. The variety of chargers and connectors needed to service the variety of mobile devices on the market makes providing comprehensive service cost-prohibitive. The provider of the charging hardware may also fear liability for devices stolen while left unattended at a charging station. Space and power-usage may be additional concerns.

Furthermore, many conventional charging systems use USB data interfaces and host computers to provide device-charging functions. These systems present multiple drawbacks. First, the universal serial bus (USB) data specification limits current to 500 mA, which is insufficient for rapid charging. Second, many mobile devices will detect when a data connection is being attempted with a host computer system and present warnings or trust-related dialogs to the user. These warnings may lead users to perceive that the charging system is attempting to access private data and prevent use of the charging system.

Thus, conventional public device-charging options are not sufficiently rapid, secure, convenient, or cost-effective. Furthermore, none of the conventional solutions provide sufficient economic incentive for installation and maintenance. Accordingly, it is desirable to provide rapid, secure, convenient, and cost-effective methods and systems for charging of mobile devices.

### SUMMARY OF THE INVENTION

Systems and methods for securely and intelligently charging mobile devices are provided. In one embodiment, the charging system obtains data associated with a payment method, makes a determination as to whether there are any available charging bays, attempts to charge the account associated with the payment data, and, responsive to a determination that the payment was successful, opens the door of the available charging bay and presents a user interface comprising information regarding connection of the mobile device.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings aspects of embodiments that are presently preferred. It should be understood, however, that the invention is not limited to the precise arrangements and instrumentalities shown.

FIG. 1 is a simplified exemplary diagram of an environment in which the mobile device charging stations could be deployed;

FIG. 2 is a simplified exemplary hardware component diagram of an embodiment of a mobile device charging system;

FIG. 3 is a software architecture diagram of an embodiment of the invention;

FIG. 4 is a flow chart of a method of providing device charging;

FIG. 5 is a flow chart of a method for managing access to a charging bay associated with an active charging session.

### DETAILED DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

The present disclosure relates to a secure charging station for multiple mobile devices. The system may be configured to allow a user adequate time for connection of a device while preventing the charging of multiple devices in a single session. The system may further provide advertising features.

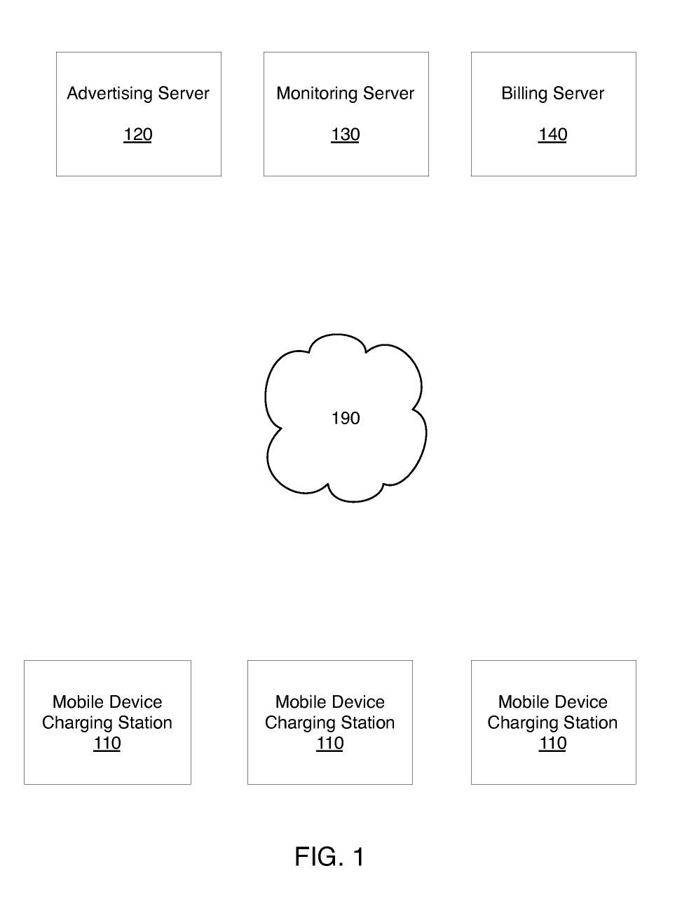

Referring to the drawings in detail, wherein like reference numerals indicate like elements throughout, FIG. 1 is a simplified exemplary diagram of an environment in which the mobile device charging stations could be deployed. One or more mobile device charging stations may be installed at locations such as cafés, restaurants, or airline terminals. Mobile device charging station 110 may connect to a variety of servers via a network 190, which may comprise portions of the Internet. Mobile device charging system 110 may connect to the network via wired or wireless means, and may use local area network (LAN) or cellular technology to connect. The connection may be “always-on” or made on-demand as needed.

Advertising server 120 provides advertisement data to mobile device charging systems 110 for presentation on the mobile device charging system user interface. Advertising server 120 may periodically, or aperiodically, send advertisement data to mobile device charging systems 110, or mobile device charging systems 110 may request advertisement data from advertising server 120 on a periodic or aperiodic basis.

Monitoring server 130 provides monitoring and diagnostics functions for mobile device charging systems 110. Mobile device charging systems may periodically send data to monitoring server 130 or monitoring server 130 may periodically poll mobile device charging systems to obtain status or performance information.

Billing server 140 provides payment-processing functions for mobile device charging systems 110. Billing server 140 may be under the control, for instance, of the mobile device charging system service provider or may be provided by one or more financial institutions or financial service providers.

Each of the described servers may be implemented on separate computers, combined on a single computer, or be deployed across multiple computers, such as in a load-balanced, scalable cloud architecture. Similarly, instances of each server may be deployed as software running on physical server hardware or on virtual server instances.

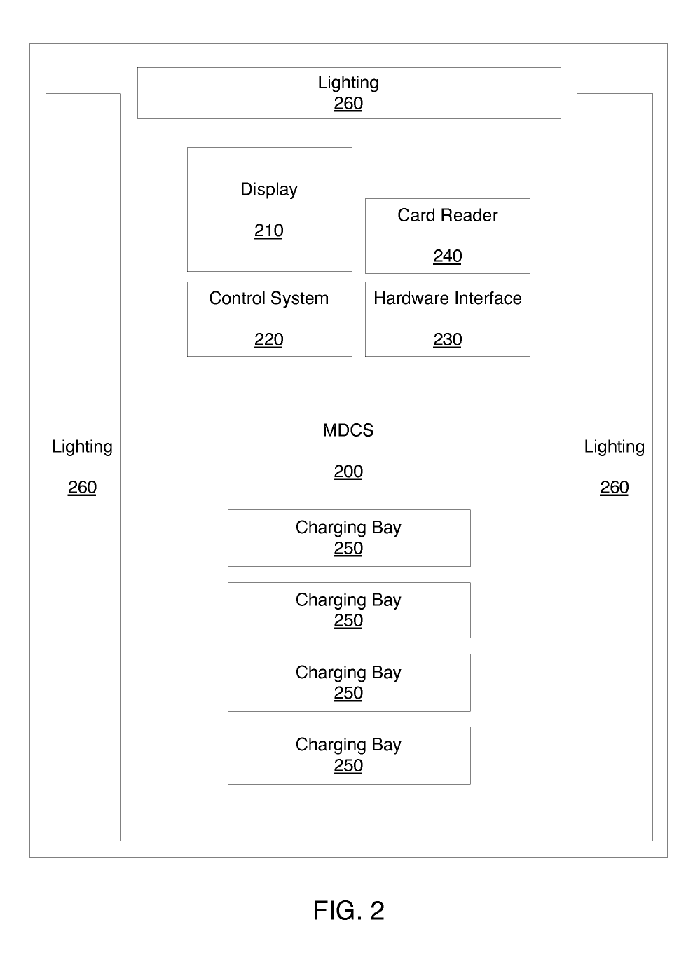

FIG. 2 is a simplified exemplary hardware component diagram of an embodiment of a mobile device charging system 200. Display 210 is used to display a user interface, and in a preferred embodiment, includes touch-screen capabilities to accept user input. Control system 220 comprises a computing platform for running the operating software for the mobile device charging system 200. In a preferred embodiment, the functionality of display 210 and control system 220 are both provided by a tablet computing device. In a preferred embodiment, the tablet computing device uses the Google Android operating system and provides a USB interface for connectivity to hardware interface 230. Control system 220 may have associated flash memory or hard drive storage for storing program code, user interface graphics, advertising data, diagnostic information, and other data.

### Hardware Interface Board

Hardware interface 230 provides control functionality for various hardware components of mobile device charging system 200, for instance, charging bay 250 doors, the charging system, and lighting 260. In a preferred embodiment, hardware interface 230 is a printed circuit board (PCB) comprising a microcontroller or microprocessor. In a preferred embodiment, hardware interface 230 comprises means, or comprises means to interface with, current measuring hardware, such as one or more ammeters, for monitoring device charging activity. Measurement of current may allow mobile device charging system 200 to determine whether mobile devices are connected and to protect circuitry from excess current.

Hardware interface board 230 may be implemented as a component of an overall system board comprising a processor or as a separate board accessible from the control system 220 via a communications interface, such as USB. In a preferred embodiment, hardware interface 230 provides control and/or access to a credit card reader or other device for obtaining payment information 240, bay doors, charging hardware, and halo lighting 260. Hardware interface 230 may also comprise memory for storage of data related to hardware state, timing, or other aspects of operation.

In a preferred embodiment, the control system 220 or other electronics are connected via a USB connection to the interface board 230, with the control system 220 as the USB slave and the interface board 230 as the USB host. Hardware state may be determined by periodic polling, either by the hardware interface 230 or at the initiation of the control system 220.

Card reader 240 provides functionality related to detecting and/or reading payment data. In a preferred embodiment, card reader 240 is a magnetic strip reader for reading data from credit cards. In other embodiments, additional or alternative hardware may be provided for unidirectional or bidirectional communication related to obtaining payment-related information, such as near-field communication hardware or Bluetooth or other radio hardware. In still other embodiments, card reader 240 may be replaced with a cash acceptance subsystem. While the examples below may refer to reading of magnetic strip cards, it is to be understood that any mechanism for obtaining payment or account data falls within the scope of the invention.

Mobile device charging system 200 also comprises one or more charging bays 250. Charging bays are preferably designed for individual access, such that a user accessing a bay in which his device is charging is unable to reasonably access a device of another user in another bay. Each charging bay preferably has an individual door under the control of hardware interface 230 and control system 220.

Charging bay 250 doors may preferably be in a horizontal orientation to allow easier viewing of the enclosed mobile devices. Charging bay 250 doors may also preferably be designed with a breakaway feature. Doors may be designed to pivot down under a load and spring back up when the load is removed, providing more robustness to abuse in field. Charging bay 250 doors may preferably have at least three points of attachment to help prevent prying. A sensor may be used to detect whether the door is open or closed. In a preferred embodiment, a Hall effect sensor may be used to sense whether a door is closed or open.

Each charging bay 250 may preferably be identical to each other bay to simplify manufacture and service. In one preferred embodiment, eight bays 250 are provided, though any number of bays would be within the scope of the present invention.

In a preferred embodiment, each device charging bay 250 provides at least four types of mobile device connections, such as Apple 30-pin, Apple Lightning, Mini USB, and Micro USB connectors.

Charging bay 250 doors may preferably be pre-sprung and use a normally closed latch. Solenoids under the control of hardware interface 230 may be used to open the latch, allowing the pre-sprung door to open. In a preferred embodiment, the user manually closes the charging bay 250 door when appropriate to secure the mobile device during charging.

Each charging bay may also comprise illumination under the control of hardware interface 230 and control system 220. In a preferred embodiment, variable-color LED illumination is provided and colors are used to indicate availability or charging status of mobile devices within the bays.

In a preferred embodiment, the system is designed to allow simplified access and service. Components may be mounted on hinged front plate. When unlocked, the plate may swing open to provide access. The charging bays made be designed to be modular and self contained. Bays may be sized to handle the largest phone for sale in the market, or may be designed to be even larger to accommodate tablet computers or laptops. The enclosure of mobile device charging system 200 may be preferably designed with an aluminum door and mounting plate with tight tolerances to avoid unwanted access by prying.

The system may preferably utilize both 5V and 12V DC power converted from wall power. The 12V system may preferably be used to power a card reader and to open doors via solenoid. The 5V system may be used for powering the interface board, user interface, and system electronics, and to provide charging current.

### Halo Lighting

In a preferred embodiment controllable color lighting 260 is provided around outside of the unit. In a preferred embodiment, the color and intensity of the illumination is under the control of the system software and may be coordinated with displayed advertising content. All or a portion of the lighting may preferably be directed out the rear of the device to provide halo illumination on a wall to attract attention to the device. In preferred embodiments, lighting 260 spans at least three edges of the rear perimeter of the enclosure.

In a preferred embodiment, mobile device charging system 200 further comprises a slim front fascia that serves the dual purpose of providing an angled sight line and secure housing of the tablet computing device providing the functions of control system 220 and display 210.

### Software Architecture Layers

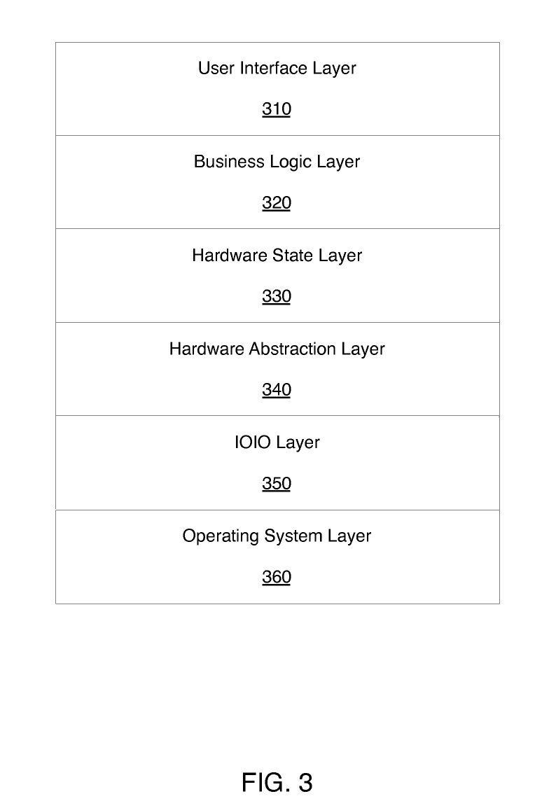

FIG. 3 is a software architecture diagram of an embodiment of the invention. User interface layer 310 comprises software program code and audio and visual assets associated with the user interface of the mobile device charging station. Business logic layer 320 comprises software program code related to rules for providing access to charging bays, providing charging to mobile devices, processing payments, and retrieving and presenting advertisements, among other functions.

Hardware state layer 330 comprises program code related to high-level commands and requests related to the mobile device charging station hardware and maintenance of information about the state of various hardware components (e.g., door open or closed, lights on or off). Hardware abstraction layer 340 comprises program code related to interaction with the mobile device charging station hardware elements. Hardware abstraction layer 340 may comprise an application program interface (API) for abstraction of the hardware elements to allow simplified programming or common programming for use with variations of hardware.

IOIO layer 350 provides input/output functions. In a preferred embodiment, the IOIO layer 350 translates commands received via USB to analog signals, which are used to control the mechanical hardware, and translates analog signals to digital data that is then provided over USB. In a preferred embodiment, the IOIO layer 350 utilizes a “IOIO for Android” or “IOIO-OTG” board, which communicates via the Android debug USB channel, and acts as the master controller of communications to and from the tablet.

The operating system layer 360 provides access to system functions of the host platform, as well as access to communications interfaces associated with the platform. In a preferred embodiment, OS layer 360 is a variant of the Google Android operating system. It is to be understood that other operating systems, including embedded operating systems, may also be utilized within the scope of the invention.

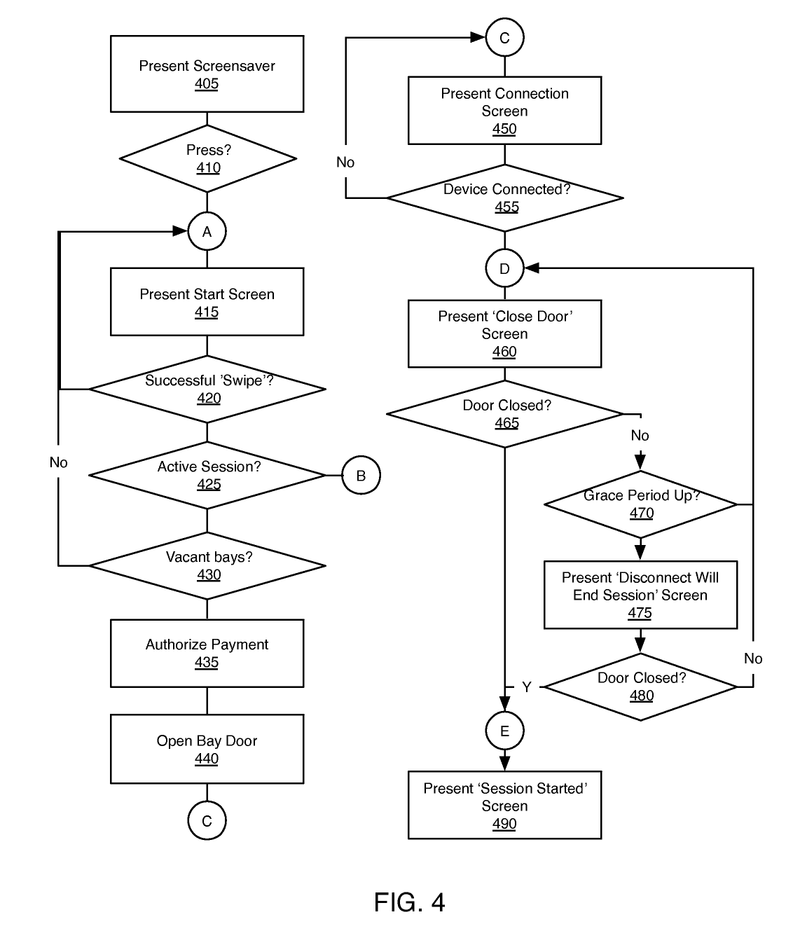

FIG. 4 is a flow chart of a method of providing device charging. It is to be understood that the figure describes one embodiment of the method, and that particular examples may describe one path through the flowchart, but are not intended to be limiting. Furthermore, certain steps, particularly those related to timeouts and errors have been omitted from the figure for clarity. The method may be implemented, at least in part, by software code executed by control system 220 and by software or firmware associated with hardware interface 230.

At 405, in the present example, the mobile device charging system is displays a screen saver, potentially with one or more advertisements. The system monitors for interaction with the touch screen display at 410 and continues display of the screensaver at 405 as long as a press is not detected. Upon detection of a user interaction with the screen, the user interface displays a screen at 415 for initiation of the device charging process. The user may be instructed by text of graphics on the user interface display to initiate a payment process, for example, by swiping a credit card. Again, as described above, magnetic strip cards are merely one example of payment method used for illustration. Other payment methods are also within the scope of the invention.

If at 420 the swiped card is found to be readable, the system may execute an intermediate check, not shown, to determine whether any of the charging bay 250 doors are open. If a door is open, the user may be instructed to close all open doors before proceeding. If the doors are not then closed, the session may be canceled and the method may return to 405. In a preferred embodiment, if the charging bay door is left open longer than a predetermined period of time, such as 30 s, or a longer time such as 90 s in the active session flow, an alert may be sent to the server and the process may return to the start screen at 415.

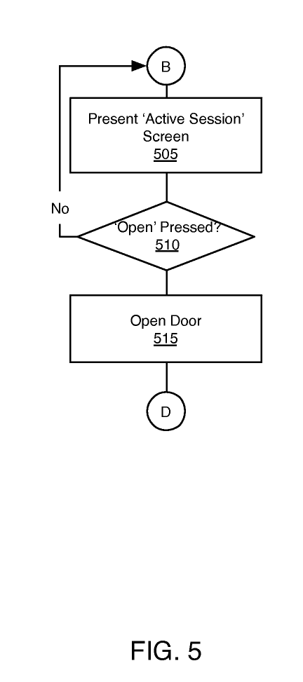

With doors closed and a credit card read, the system checks at 425 for an already active session associated with the swiped card. This situation would occur when a user is returning to retrieve a charged device. If there is an active session associated with the swiped card, the process moves to the steps shown in FIG. 5.

In the case of a new charging session, however, the system will proceed to 430 to check for a vacant bay to be used for the new charging session. If a charging bay is available for the new session, the system will attempt to authorize payment for the session at 435. Payment authorization may comprise communication between mobile device charging system 110 and billing server 140. In a preferred embodiment, payment is completed at the initiation of the charging session. In other embodiments, the payment may be completed at the end of the session or may be deducted at any time from an account associated with the user. If the payment authorization is not successful, the system may present a user interface indicating that there was a problem, perhaps suggesting that the user swipe the card again or use an alternative form of payment.

If the payment is determined to be successful, the process proceeds to 440 and the door of an available bay is opened. As described above, the opening of a bay door may be initiated by software instructions executed on control system 220, causing control of hardware interface 230, and in turn, activation of a solenoid associated with the desired door, to cause the door to open.

At 450, the system presents a user interface to direct the user to connect the mobile device. The mobile device charging system may also present a screen with terms of service before or after presenting instructions, and may require user acknowledgement of those terms before the user is allowed to continue.

At 455, the system determines whether a mobile device has been attached to one of the connectors in the open bay. If not, the method continues to present the connection screen of 450. Once a device is connected, a user interface screen is presented at 460 instructing the user to close the charging bay door. As with other user interface screens, the screen instructing the user to close the charging bay door may comprise text, graphics, sound, or animations, in any combination.

In a preferred embodiment, the connection screen may comprise a user interface element for allowing the user to cancel the request for a charging session. If this user interface option is selected, or if a certain amount of time has passed without a device being connected, the user may be presented with warnings and/or eventually a message that the session has been terminated. If, after session termination, the user connects a device to a connector in the open bay, the connection may be detected and a user interface screen may be presented noting that the session has ended and that the charging bay door must be shut to allow initiation of a new session. If the user shuts the door, the session initiation process may begin again at 415.

At 465, a determination is made as to whether the charging bay door has been closed. If the door has not been closed, the user interface continues to present instructions to the user to close the door. In a preferred embodiment, after a predetermined amount of time has passed, the user interface may present an additional, potentially more noticeable, warning to the user to close the door.

### Grace Period

In a preferred embodiment, the system may provide a certain amount of time, referred to herein as a grace period, to allow the user time to attach the device to the charging bay connector and close the door. In a preferred embodiment, the grace period may be on the order of one-to-three minutes.

One function of the grace period may be to prevent multiple devices from being significantly charged during a single paid charging session. This may be done, for instance, to prevent loss of revenue associated with charging of the second device.

It is a common property of mobile devices that the current draw decreases as the device nears a fully-charged state. If, after detection of disconnection of a mobile device and reconnection of a mobile device, there is a significant increase in current draw, the conclusion may be drawn that a different, less fully-charged device has been connected. The system may be configured such that if such an exchange is detected during the grace period, the exchange may be allowed and charging of the newly connected device may proceed. However, the system may also be configured such that if the grace period has expired, the charging session is terminated. Measurement of current may be performed by an ammeter under the control of hardware interface 230 and control system 220.

If the system determines that a mobile device is not connected, it may prevent the charging bay door from being shut. The user is then preferably presented a message indicating that the mobile device is not properly connected. Similarly, if the system detects that there is no current draw during the grace period, it may direct the interface board to re-open the charging bay door.

If the door remains open and a determination is made at 470 that a predetermined grace period has expired, the user interface may present an indication that subsequent disconnection of the mobile device will result in session termination. Among other benefits, this prevents a user from keeping the door open to charge multiple mobile devices during a single paid session. Once the door is closed, either at 465 or at 480, the user interface presents an indication that the charging session has started at 490.

It is to be understood that while some of the steps of the method are best performed in a particular order, many may be reordered within the scope of the invention. For instance, the charging bay door may be opened at 445 before or after instructions are presented regarding connection of the device at 450.

FIG. 5 is a flow chart of a method for managing access to a charging bay associated with an active charging session, for instance, when a user returns to retrieve the mobile device after a period of charging. The described process flow is an example of how one embodiment of the present system may address identification of the return of a user associated with an active session.

In the present example, a credit card is swiped that is associated with an existing charging session, such as at step 425 of FIG. 4. In other embodiments, proximity sensing, entry of a code, insertion of a claim ticket, or other methods may be used to detect the return of the user to the mobile device charging system.

At 505, the user interface presents a screen indicating that there is an active session associated with the presented identification. The user interface may comprise a selectable element, such as an “OPEN” button, to allow the user to request opening of the door of the charging bay containing the user's mobile device.

Upon detecting selection of the user interface element associated with opening the charging bay door at 510, the door is opened at 515. In some embodiments, the appropriate charging bay door may be opened upon detection of the associated credit card or other identifier without a specific user interaction related to opening the door. The process then generally proceeds from 460 as it would during the setup of a new session. If time remains in the grace period, the user may be able to disconnect and reconnect the mobile device, and/or shut the door to continue the charging session. If the grace period has expired, disconnection of the device may terminate the charging session.

### Charging

Instead of a host computer system, preferred embodiments of the present invention use a DC power system and one or more ammeters to measure current passing to the mobile devices. This allows devices to be charged more quickly and avoids generation of warnings on the mobile device due to connection to a host computer. The mobile device charging system preferably uses a 5V charging system. While USB may be used for the connection, the system connections may be compliant with portions of the USB specifications related to dedicated chargers, rather than data connections. Since the mobile device charging system appears to the mobile device as a dedicated charger, much higher charging current may be allowed, for instance, up to 2 A. Ammeter readings may be averaged over time to account for short-term fluctuations.

### Advertising

The system may also preferably present advertising, either for the mobile device charging service itself or for third party products or services. The system may display a screen saver on the user display with advertising content. Advertising revenue may be used to offset the cost of purchase and operation of the mobile device charging system. Venue owners may, in some instances, be provided with a portion of the advertising revenue as compensation for hosting and powering the system. Venue owners may also be offered the opportunity to advertise their own products or services on the device. Advertising revenue or opportunities for advertising, therefore, may directly or indirectly provide incentive to the venue operator to provide device charging to patrons.

In a preferred embodiment, the charging system retrieves advertisements for display over a network, such as the Internet. An advertising server may provide an application programming interface (API) for retrieval of advertising content. In a preferred embodiment, the advertising server provides a representational state transfer (REST) API and is implemented at least partially in Python code. The mobile device charging system may connect to the advertising server 120 as needed to retrieve new advertising content. In other embodiments, new advertising content may be delivered to the charging station via a variety of methods such as file transfer protocol, email, push notifications, or other known methods.

### Monitoring

The system may further provide the ability to track user analytics data and send remote maintenance and configuration commands to an on-premise charging kiosk. A central server may 130 provide remote monitoring functions for a number of charging stations. Upon detection of a problem at the server, personnel at the site where the fault occurred may be contacted to take corrective action.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for controlling access to a charging bay of a charging station with a plurality of charging bays and a graphical user interface, comprising:
obtaining data associated with a payment method;
responsive to a determination that there are no active charging sessions associated with said data associated with a payment method, making a determination as to whether there is an available charging bay;
responsive to a determination that a bay is available, attempting to process a payment using said data associated with a payment method; and
responsive to a determination that said attempt to process a payment was successful, opening the door of the available charging bay and presenting a user interface comprising information regarding connection of the mobile device.

2. The method of claim 1 further comprising:
responsive to a determination that a device was connected to a connector in the available charging bay, presenting a user interface comprising a message directing the user to close the door of the charging bay.

3. The method of claim 2 further comprising:
responsive to a determination that a predetermined grace period has expired, presenting a user interface comprising a message indicating that the device charging session will be terminated if the device is disconnected.

4. The method of claim 3 further comprising:
responsive to detecting that said device was disconnected, terminating the device charging session.

5. The method of claim 2 further comprising:
responsive to a determination that the door of the charging bay was closed, presenting a user interface comprising a message indicating that the device charging session has been initiated.

6. The method of claim 2 further comprising:
responsive to a determination that a predetermined time interval has elapsed and that the charging bay door has not been closed, presenting a user interface comprising a message instructing the user to close the charging bay door.

7. The method of claim 1 further comprising:
presenting an advertisement on said graphical user interface.

8. The method of claim 7 further comprising:
retrieving data related to said advertisement via a network.

9. The method of claim 1 wherein obtaining data associated with a payment method comprises obtaining data from one of: a swipe of a credit card, a contact of an identifying device, or the placement of a device with near-field communication capability within proximity of the charging station.

10. A method for controlling access to a device chamber of a charging station comprising:
obtaining data associated with a payment method;
responsive to a determination that there is an active charging session associated with said data associated with a payment method, presenting a user interface screen comprising data associated with said charging session.

11. The method of claim 10 further comprising:
presenting, on said user interface screen, a user interface element associated with opening the charging bay associated with said active charging session; and
responsive to an indication that a user has selected said user interface element associated with opening the charging bay associated with the active charging session, opening the door of the charging bay associated with said active charging session.

12. The method of claim 10 further comprising:
responsive to a determination that said obtaining data associated with a payment method was unsuccessful, presenting an error screen prompting the user to perform an action associated with said payment method.

13. The method of claim 10 further comprising:
presenting an advertisement on said graphical user interface.

14. The method of claim 10 wherein said data associated with said charging session comprises at least one of: an amount of time the device was charged, a fee, or an identifier of a charging bay.

15. A system for providing mobile device charging, comprising:
a housing;
a touch-screen display;
a plurality of charging bays; and
a control system, comprising a processor for executing program code for:
obtaining data associated with a payment method;
responsive to a determination that there are no active charging sessions associated with said data associated with a payment method, making a determination as to whether there is an available charging bay;
responsive to a determination that a bay is available, attempting to process a payment using said data associated with a payment method; and
responsive to a determination that said attempt to process a payment was successful, opening the door of the available charging bay and presenting a user interface comprising information regarding connection of the mobile device.

16. The system of claim 15 further comprising substantially rear-directed color-controllable lighting.

17. The system of claim 16 wherein said rear-directed color controllable lighting is along at least three edges of the perimeter of the rear of said housing.

18. The system of claim 15 wherein said touch-screen display is mounted within a slanted upper portion of the front surface of said housing.
